(19) United States
(12) Patent Application Publication
(10) Pub. No.: US 2025/0245483 A1
(43) Pub. Date: Jul. 31, 2025

(54) COMPLETENESS GRAPH GENERATOR

(71) Applicant: Intuit Inc., Mountain View, CA (US)

(72) Inventors: Karelia Del Carmen Pena Pena, Wilmington, DE (US); Ankita Sinha, Mountain View, CA (US); Goutham Kallepalli, Sunnyvale, CA (US); Malathy Muthu, The Woodlands, TX (US)

(73) Assignee: Intuit Inc., Mountain View, CA (US)

(21) Appl. No.: 18/423,128

(22) Filed: Jan. 25, 2024

(51) Int. Cl. G06N 3/0455; G06N 3/092

(52) U.S. Cl. CPC G06N 3/0455; G06N 3/092

(57) ABSTRACT

Systems and methods are described for training a large language model to operate as a completeness graph generator to automatically generate completeness graphs in response to queries based on instructions including forms, rules, and regulations. A dataset is obtained that includes instructions and associated ground truth completeness graphs, previously generated manually by domain experts. An active large language model is trained configured to produce a generated completeness graph in response to a query that is evaluated with a reward model based on validity of the generated completeness graph and semantic similarity of the generated completeness graph and the associated ground truth completeness graph. The active large language model is re-trained based at least partially on the reward.

### TECHNICAL FIELD

Aspects of the present disclosure relate to generating a user experience based on a knowledge engine.

### BACKGROUND

Organizations, such as businesses (e.g., for profit, non-profit, etc.), governing authorities (e.g., country, state, county, city, etc.), and other such entities have implemented compliance regimes with the assistance of a knowledge engine. In some cases, an organization can implement a compliance regime through a software program product that includes a knowledge engine service.

A compliance regime can include rules and regulations associated with knowledge domain(s), including tax, finance, accounting, health care, data protection, and so forth. Knowledge engineering is an important field of artificial intelligence oriented to building systems that emulate the judgment and behavior of a human expert by codifying knowledge as rules and relationships between data. With a knowledge engine, domain experts and product teams manually create knowledge graphs (semantic network) that represent knowledge in a way that can be reasoned about with computer programs. Knowledge graphs, for example, may include calculation (calc) graphs and completeness graphs, which are representative of the rules and regulations of the compliance regime, capable of implementing the compliance regime. A calc graph and a completeness graph each can include a set of nodes that are encoded with related content. A calc graph uses calculations that are part of the compliance regime as its nodes to generate a result, and a completeness graph can determine whether any information needed for compliance is missing, e.g., to define what questions users need to answer to complete a given task.

For example, in the instance of a tax compliance regime, an organization can implement a software program product that includes a knowledge engine (e.g., as a service). The completeness graph(s) of the knowledge engine can determine what inputs are needed and if all of the inputs have been received, while the calc graph(s) generates a complete tax calculation (e.g., for a completed annual tax return, using data required by the completeness graph such as number of dependents, income, etc.) within the software program product.

Optimizing the number of questions that are presented to users using a completeness graph is important to guarantee a smooth and customized user experience in any product. Compliance regimes, however, are not static, and new rules and regulations can be added (at any time and for any reason) to expand and/or modify the compliance regime. For an organization that implements a compliance regime, any changes in the rules and regulations include adding and/or modifying the knowledge graphs. To do so, for example, involves modifying a software program product to include the latest rules and regulations for an up-to-date and accurate user experience that meets the compliance regime. Conventional methods for adding and/or modifying knowledge graphs are resource-intensive (e.g., time, money, computing, personnel, etc.). For example, currently, completeness graphs are manually authored which involves a laborious process fraught with considerable time and financial costs.

Therefore, a solution is needed that can overcome the shortcomings of the conventional methods so as to generate a user experience based on the knowledge engine and, specifically knowledge graphs such as a completeness graph, without monopolizing resources.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable features disclosed herein.

In one aspect, a method of training a large language model to generate completeness graphs includes obtaining a dataset comprising instructions and ground truth completeness graphs associated with the instructions. A generated completeness graph is produced with an active large language model in response to a query based on instructions from the dataset. The method includes evaluating the generated completeness graph with a reward model to produce a reward that is based on validity of the generated completeness graph and semantic similarity of the generated completeness graph and the associated ground truth completeness graph. The active large language model is re-trained based at least partially on the reward.

In one aspect, a system of training a large language model to generate completeness graphs includes one or more processors and a memory coupled to the one or more processors and storing instructions that, when executed by the one or more processors, cause the one or more processors to perform operations. The one or more processors, for example, are configured to obtain a dataset comprising instructions and ground truth completeness graphs associated with the instructions and produce a generated completeness graph with an active large language model in response to a query based on instructions from the dataset. The one or more processors are further configured to evaluate the generated completeness graph with a reward model to produce a reward based on validity of the generated completeness graph and semantic similarity of the generated completeness graph and the associated ground truth completeness graph. The active large language model is re-trained based at least partially on the reward.

### BRIEF DESCRIPTION OF THE DRAWINGS

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

FIG. 1 shows a block diagram of a computing system configured for training a completeness graph generator to generate completeness graphs, according to some implementations.

FIG. 2 is an illustration of a completeness graph in the form of a logical tree with nodes and edges representing a simplified or generalized version of a completeness graph.

FIG. 3 illustrates a transformer based reinforcement learning approach to train a completeness graph generator to automatically generate completeness graphs, according to some implementations.

FIG. 4 shows an illustrative flowchart depicting an example method for training a completeness graph generator to automatically generate completeness graphs in response to queries, according to some implementations.

FIG. 5 illustrates an example of instructions and an associated ground truth completeness graph that may be included in the dataset of training data.

FIG. 6 shows an illustrative flowchart depicting an example method for fine tuning a pre-trained model using domain adaptation techniques in order to generate completeness graphs.

FIG. 7 illustrates a comparison of completeness graphs to determine a semantic similarity.

FIG. 8 shows an illustrative flowchart depicting an example method for optimizing a policy using a reward model.

FIG. 9 illustrates the process of generating the completeness graph generator using transformer based reinforcement learning, as discussed herein.

FIGS. 10A-10C illustrate a process of training an active model using Proximal Policy Optimization (PPO) based on reward.

FIG. 11 illustrates a process of generating the completeness graph generator using transformer based reinforcement learning using Kullback-Leibler (KL)-divergence.

FIG. 12 illustrates a flowchart depicting an example method for training a large language model to generate completeness graphs, according to some implementations.

Like reference numbers and designations in the various drawings indicate like elements.

### DETAILED DESCRIPTION

Aspects of the present disclosure provide apparatuses, methods, processing systems, and computer readable mediums for generating a user experience based on a knowledge engine. In particular, systems and methods are described regarding automatically generating and optimizing generating completeness graphs in a knowledge engine. The disclosed implementations streamlines the process of generating completeness graphs, significantly reducing the expenditure of resources, while simultaneously enhancing accuracy and consistency, to foster a more effective and cost-efficient process of generating completeness graphs to improve user experience in various application domains. One of the multiple applications with which the completeness graphs may be used is the development of software for preparing tax returns, which is sometimes used herein by way of example, but is not intended as a limitation.

Knowledge engines use knowledge graphs (semantic networks) to represent knowledge in a way that can be used with computer programs. A completeness graph is a graph used with a knowledge engine and, for example, defines the questions that users need to answer in order to complete a given task. Optimizing the number of questions and presentation of the questions to users is important for a smooth and pleasant user experience. Conventionally, completeness graphs are prepared manually based on current domain knowledge, e.g., rules, regulations, or other information applicable to the relevant application domain, which involves a laborious process that is time consuming, expensive, and prone to errors. Domain knowledge, such as forms, rules and regulations, however, are not static. For example, forms, rules, and regulations may be added or changed over time, thereby expanding and/or modifying the domain knowledge. Any changes in the domain knowledge may require adding and/or modifying completeness graphs, which if performed manually is time consuming and expensive.

With a trained model that is configured to automatically generate and optimize completeness graphs in the knowledge engine, it is possible to remain current with changes in the domain knowledge while reducing the expenditure of resources and enhancing accuracy and consistency, thereby providing improved user experiences.

In the implementations described herein, a completeness graph generator, including a machine learning model, such as a large language model, may be trained to automatically generate completeness graphs from textual information, i.e., the forms, rules, and regulations in the domain knowledge. The completeness graph generator may be trained to extract form details, generate instructions, and associate field information with user questions by implementing an efficient pipeline of engineered prompts, sometimes referred to here as a Domain-Specific Knowledge Repository. Artifacts from this repository may be used as inputs for the completeness graph generator, which may be trained using a Transformer based Reinforcement Learning approach, leveraging large language model capabilities, e.g., in a zero shot mode execution. This methodology may facilitate the seamless generation of an equivalent representation of completeness, optimizing data management for regulatory forms and streamlining the form filing process, ultimately resulting in enhanced efficiency and improved user experience in document preparation, processing, and completeness graph generation.

By way of example, in some implementations, a large language model may be trained to generate completeness graphs using a dataset of training data including instructions, e.g., forms, rules and regulations, and associated ground truth completeness graphs, e.g., previously generated manually by domain experts. The large language model may be trained to produce completeness graphs in response to queries from the dataset. The large language model, for example, may be a pretrained model that is fine-tuned, e.g., using domain adaptation techniques to generate completeness graphs. The generated completeness graphs from the large language model may be evaluated with a reward model, which generates a reward based on, e.g., the validity of the generated completeness graphs and the semantic similarities of the generated completeness graphs to associated ground truth completeness graphs. Additionally, in some implementations, the generated completeness graphs produced by the active large learning model may be compared to a completeness graphs produced a reference large learning model to determine a divergence value, which may be used to modify the reward. The active large learning model may then be re-trained, e.g., optimized, based on the reward in a reinforcement learning approach.

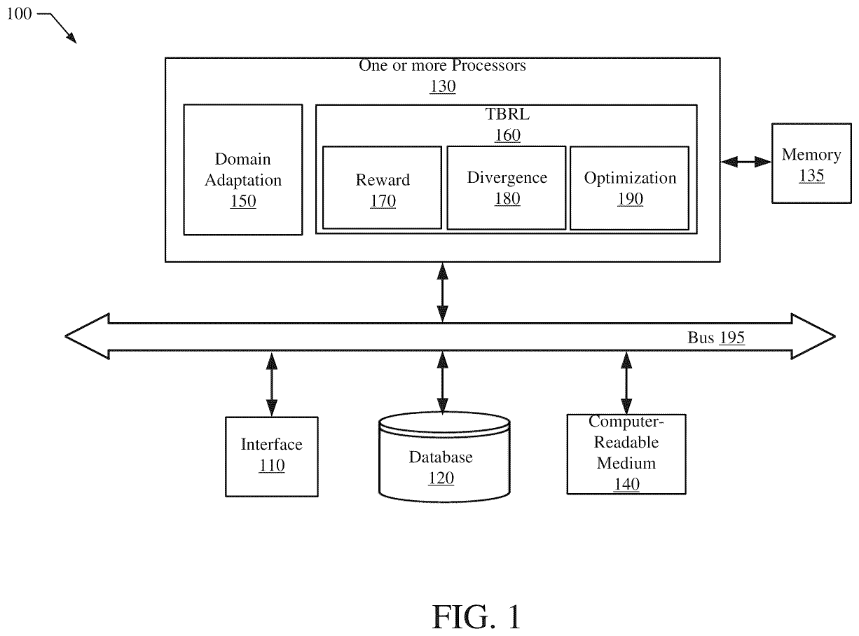

FIG. 1 shows an example computer system 100 configured for training a model to generate completeness graphs, according to some implementations. The computer system 100 is shown to include an interface 110, a database 120, one or more processors 130, a memory 135 coupled to the one or more processors 130, and computer-readable medium 140. In some implementations, the various components of the computer system 100 may be interconnected by at least a data bus 195, which may be any known internal or external bus technology, including but not limited to ISA (Industry Standard Architecture), EISA (Extended Industry Standard Architecture), PCI (Peripheral Component Interconnect), PCI Express, NuBus, USB (Universal Serial Bus), Serial ATA (Serial Advanced Technology Attachment), or FireWire. In other implementations, the various components of the computer system 100 may be interconnected using other suitable signal routing resources, for example, the components may be distributed among multiple physical locations and coupled by a network connection.

The computer system 100 is configured for training a learning model to automatically generate completeness graphs for a knowledge engine that represent rules and regulations of a knowledge domain. By way of example, in a tax knowledge domain, the completeness graphs may represent the forms, rules, and regulations for generating questions for users to obtain information necessary for preparing accurate and complete tax returns, such as the number of dependents, taxable deductions, etc. The development of software for preparing tax returns, and specifically completeness graphs used for tax returns, is sometimes used herein as an example, but it is not intended as a limitation. Completeness graphs may be generated for knowledge domains other than tax, such as medical, legal, real estate, etc. A software program product may utilize the data stored in a knowledge engine, including the completeness graphs, to provide user experiences, such as preparing and filing tax returns electronically. In some cases, the knowledge engine may be hosted on one or more servers, which may be separate from or part of the computer system 100. In other cases, the server can include a knowledge engine service that accesses the server(s) hosting the knowledge engine.

The computer system 100 may electronically receive, via the electronic interface 110, input data for generating completeness graphs. The input data, for example may include one or more datasets of training data, including instructions and ground truth completeness graphs associated with the instructions. The instructions, for example, includes the domain knowledge from which completeness graphs are to be prepared, such as forms, rules, regulations, and any other relevant information. The ground truth completeness graphs may be any previously generated completeness graphs for the associated instructions that are known to be correct. The ground truth completeness graphs, for example, may have been previously generated manually by domain experts, or in some implementations, may be completeness graphs that were previously generated by the computer system 100 and that have been manually verified or modified by domain experts to be correct. The computer system 100 may electronically receive, via the interface 110, the one or more datasets of training data, which may be stored in database 120. The system may further electronically receive, via the interface 110, machine learning models such as large language models, which may also be stored in database 120, and that are to be trained to generate completeness graphs as discussed herein. The computer system 100 may electronically transmit, via the interface 110, to a server that hosts the knowledge engine the knowledge engine or the machine learning models once trained to generate completeness graphs. In other implementations, the computer system 100 retain the machine learning models trained to generate completeness graphs, and may electronically transmit, via the interface 110, to a server that hosts the knowledge engine, one or more completeness graphs or a knowledge engine including one or more completeness graphs. Where the computer system 100 hosts the knowledge engine, the computer system 100 may retain the completeness graphs and knowledge engine, e.g., which may be stored in memory such as in database 120 and/or memory 135, and may electronically communicate with one or more servers or users via the electronic interface 110. The interface 110 may additionally include one or more input/output (I/O) interfaces to obtain administrator inputs (such as via a web portal for a remote system or user interface devices for a local system) and, in some implementations, user inputs, e.g., if the computer system 100 hosts the knowledge engine. An example interface 110 may include a wired interface or wireless interface to the internet or other means to communicably couple with other devices. For example, the interface 110 may include an interface with an ethernet cable or a wireless interface to a modem, which is used to communicate with an internet service provider (ISP) directing traffic to and from other devices (if system 100 is remote). If the computer system 100 is local, the interface 110 may include a display, a speaker, a mouse, a keyboard, or other suitable input or output elements that allow interfacing between the computer system 100 and another entity, such as an administrator or user.

The database 120 may store the domain knowledge, e.g., instructions such as forms, rules, regulations, and any other relevant information, and ground truth completeness graphs associated with the instructions, as well machine learning models including reference models and active models, i.e., models that are trained and fine-tuned to generate completeness graphs.

The one or more processors 130 may include one or more suitable processors capable of executing scripts or instructions of one or more software programs stored in system 100 (such as within the computer-readable medium 140 and/or memory 135) and that once programmed pursuant to instructions stored in memory operates as a special purpose computer. For example, the one or more processors 130 may be capable of executing instructions causing the one or more processors 130 to train, and in some implementations, to operate, a machine learning model, such as a large language model, to generate completeness graphs in response to queries based on instructions, e.g., forms, rules, regulations, and any other relevant information. The one or more processors 130 may include a single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the one or more processors 130 may include a combination of computing devices (such as a combination of a DSP and a microprocessor, a plurality of microprocessors, one or more microprocessors in conjunction with a DSP core, or any other such configuration). In some implementations, particular processes and methods may be performed by circuitry that is specific to a given function.

As illustrated, the one or more processors 130 is configured as a special purpose computer to perform the various functions discussed herein. For example, the one or more processors 130 may be configured to operate as a domain adaptation processor 150 to fine-tune a pre-trained machine learning model, such as a large language model, to produce completeness graphs in response to queries. The domain adaptation processor 150, by way of example, may be configured to use parameter-efficient fine-tuning (PEFT), such as Low-Rank Adaptation (LoRA) to enhance the learning and understanding of the large language model to produce completeness graphs.

The one or more processors 130 may be further configured to operate as a transformer based reinforcement learning (TBRL) processor 160 to train and optimize a machine learning model, such as a large language model, to automatically generates completeness graphs in response to queries from a dataset of forms, rules, regulations, etc., as discussed herein. By way of example, the TBRL processor 160 may be configured to include a reward model processor 170 that is configured to analyze generated completeness graphs produced by an active model in response to a query from the dataset of training data, e.g., based on the similarity of a generated completeness graph to an associated ground truth completeness model, and optionally based on the validity of the generated completeness graph, and to produce a reward in response. The TBRL processor 160 may be further configured to include a divergence processor 180 that is configured to analyze the generated completeness graphs to determine divergence, such as Kullback-Leibler (KL)-divergence, from completeness graphs produced by a reference model, as an additional reward signal to prevent destabilization of the learning process. The TBRL processor 160 may be further configured to include an optimization processor 190 that is configured to re-train, e.g., optimize employing Proximal Policy Optimization (PPO), the active model based on the reward(s).

The memory 135 may be any memory (such as RAM, flash, etc.) that temporarily or permanently stores data, such as any number of software programs, executable instructions, machine code, algorithms, and the like that can be executed by the one or more processors 130 to perform one or more corresponding operations or functions. In some implementations, the memory 135 may be connected directly to or integrated with the one or more processors 130, e.g., as a processing in memory (PIM) chip.

Computer-readable medium 140 may be any computer-readable medium that participates in providing instructions to the one or more processors 130, directly or via memory 135, for execution, including without limitation, non-volatile storage media (e.g., optical disks, magnetic disks, flash drives, etc.), or volatile media (e.g., SDRAM, ROM, etc.). In some implementations, hardwired circuitry may be used in place of, or in combination with, software instructions to implement aspects of the disclosure. As such, implementations of the subject matter disclosed herein are not limited to any specific combination of hardware circuitry and/or software.

Computer-readable medium 140 may include various instructions, such as instructions for implementing an operating system (e.g., Mac OS®, Windows®, Linux, etc.). The operating system may be multi-user, multiprocessing, multitasking, multithreading, real-time, and the like. The operating system may perform basic tasks, including but not limited to recognizing input from input devices in the interface 110, sending output to display devices in the interface 110, keeping track of files and directories on computer-readable medium 140, controlling peripheral devices (e.g., disk drives, printers, etc.) which can be controlled directly or through an I/O controller, and managing traffic on bus 195. Computer-readable medium 140 may further include network communications instructions to establish and maintain network connections via the interface 110 (e.g., software for implementing communication protocols, such as TCP/IP, HTTP, Ethernet, telephony, etc.).

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random-access memory or both. A computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship with each other.

One or more features or steps described herein may be implemented using an Application Programming Interface (API) and/or Software Development Kit (SDK), in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

Completeness graphs, in general, include two primary components: (1) the nodes corresponding to fields or information that is to be collected, and (2) the edges or connections between nodes that provide different paths or sets of questions that users are to answer to complete a task. The presence of different paths to complete a task allows for an improved user experience for users.

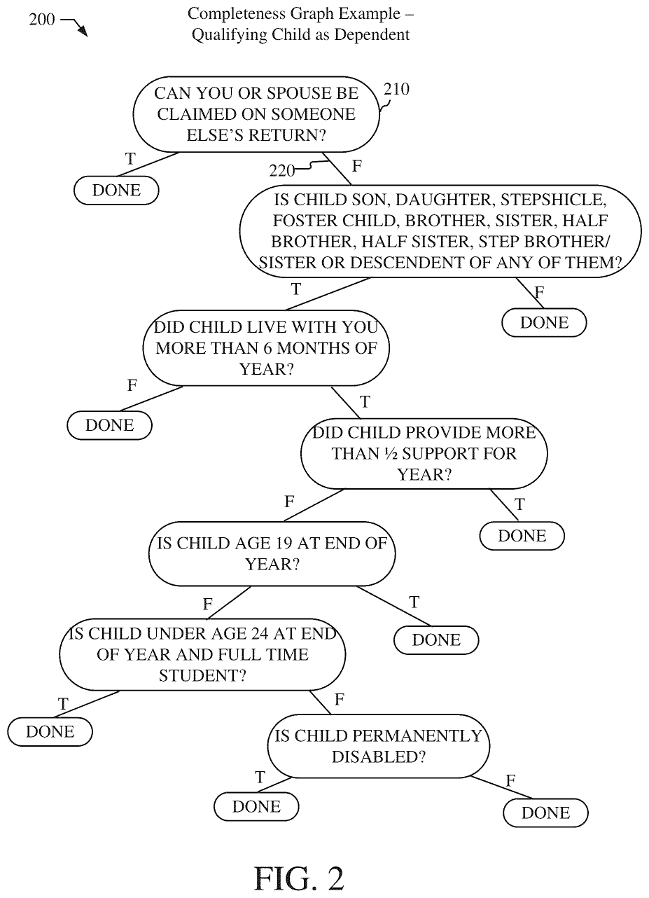

FIG. 2, by way of illustration, shows a completeness graph 200 in the form of a logical tree with nodes 210 and edges 220 representing a simplified or generalized version of a completeness graph for the topic of determining whether a child qualifies as a dependent for federal income tax purposes. Each node 210 contains a condition that in this example is expressed as a Boolean expression that can be answered, e.g., by a user, in the affirmative (T) or negative (F). The edges 220 that connect each node 210 illustrate the dependencies between nodes 210. The combination of edges 220 in the completeness graph 200 illustrates the various pathways to completion. A single edge 220 or a combination of edges 220 that result in a determination of “Done” represent a pathway to completion. As illustrated in FIG. 2, there may be several pathways to completion. For example, one pathway to completion includes an affirmative (T) answer given in response to the question of whether you or a spouse can be claimed on someone else's tax return. If such a condition is true, a child is not a qualifying dependent because under IRS rules. Another example of a pathway to completion ends with a negative (F) answer given in response to the question of whether a child lived with you for more than 6 months of the year.

Due to the complexities and nuances of the tax code, many tax topics may contain completeness graphs that have many nodes with a large number of pathways to completion. However, many branches or lines within a completeness graph may be ignored by certain users, for example, when certain questions internal to the completeness graph 200 are answered that eliminate other nodes 210 and edges 220 within the completeness graph 200. The dependent logic expressed by the completeness graph 200 allows one to minimize subsequent questions to users based on answers given to prior questions. This allows a minimum question set that can be generated and that can be presented to a user to improve user experience.

Completeness graphs are conventionally generated manually by domain experts and product teams who create completeness graphs based on instructions, e.g., forms, rules, regulations, etc., present in the relevant knowledge domain, e.g., tax, finance, accounting, health care, data protection, and so forth. For example, the completeness graph 200 illustrated in FIG. 2 may be manually generated by domain experts based on tax filing instructions. Generating and updating completeness graphs in response to new or modified instructions is a laborious process that may be expensive and time consuming.

As discussed herein, the process of generating completeness graphs may be automated by training a completeness graph generator based on a transformer based reinforcement learning approach that leverages large language model capabilities. The completeness graph generator, for example, may include a combination of components and functionalities to optimize the extraction of form details, generation of filing instructions, and association of field information with interview questions.

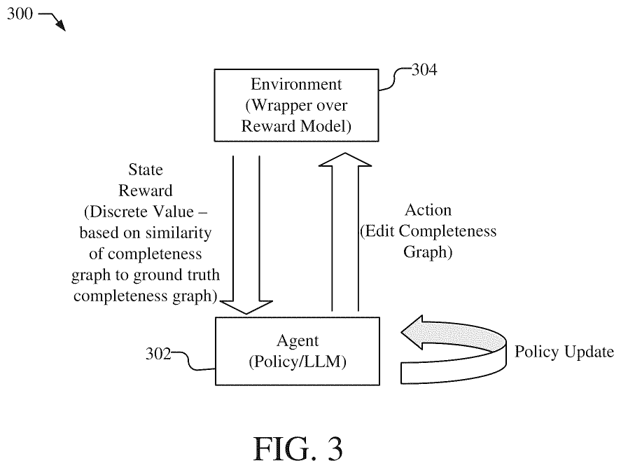

FIG. 3, by way of example, illustrates a transformer based reinforcement learning method 300 that may be used to produce a completeness graph generator that automatically generates completeness graphs, as discussed herein. In a reinforcement learning approach, an agent 302 interacts with the environment 304 by taking actions based on observations of the environment 304. The environment 304 responds to actions from the agent 302 with observations, rewards, and a “done” signal. The goal of the agent 302 is to learn a policy that maximizes the cumulative reward over time, e.g., maximize the expected sum of rewards, Eₚ(Σₜ₌₁^{T}rₜ), where t is the number of trials, and r is the reward value. The environment 304 provides the necessary information, e.g., observations, rewards, and “done” signal, for the agent 302 to learn and interact effectively.

As illustrated in FIG. 3, in the transformer based reinforcement learning method 300, the agent 302 takes actions by employing a policy, which may be a large language model (LLM), that generates or edits a completeness graph in response to an input prompt and a data model from instructions, such as tax forms and instructions on how to file the tax form. The environment 304 may be a wrapper over reward model, that evaluates the generated completeness graph with a reward model to produce a reward and a representation of the state that are fed back to the agent 302, which performs a policy update in response. The reward, for example, may be a discrete value, e.g., a value between 1-5, that is based on the evaluation of the generated completeness graph. For example, the evaluation of the generated completeness graph may be based on one or both of the validity of the generated completeness graph and the closeness, e.g., semantic similarity, of the generated completeness graph and the associated ground truth completeness graph. The agent 302 updates the policy in response to the reward and repeats the process. For example, if the value of the reward is low or has decreased, the agent 302 edits the completeness graph, which is evaluated by the environment 304. The process repeats until convergence, e.g., the completeness graph consistently receives a high reward value, at which time, the environment 304 may provide a “done” signal to the agent 302.

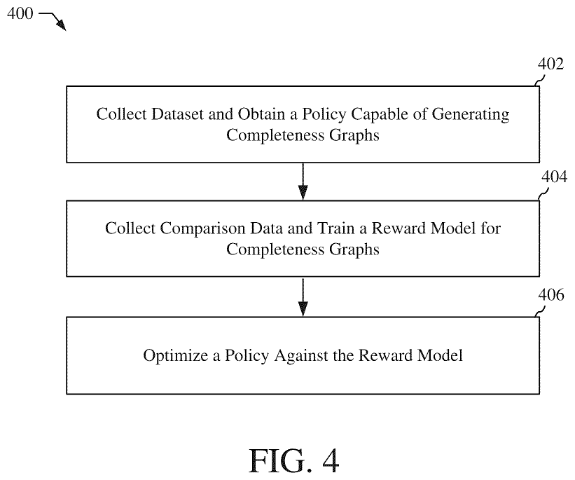

FIG. 4 shows an illustrative flowchart depicting an example method 400 for training a model, sometimes referred to as a completeness graph generator, to automatically generate completeness graphs in response to queries from updated or current domain knowledge, e.g., including forms, rules, regulations, etc., according to some implementations.

As illustrated in FIG. 4, the process of training the completeness graph generator includes collecting a dataset of training data and obtaining a policy that is capable of generating completeness graphs (block 402). The dataset of training data, for example, may be a collection of instructions and ground truth completeness graphs associated with the instructions.

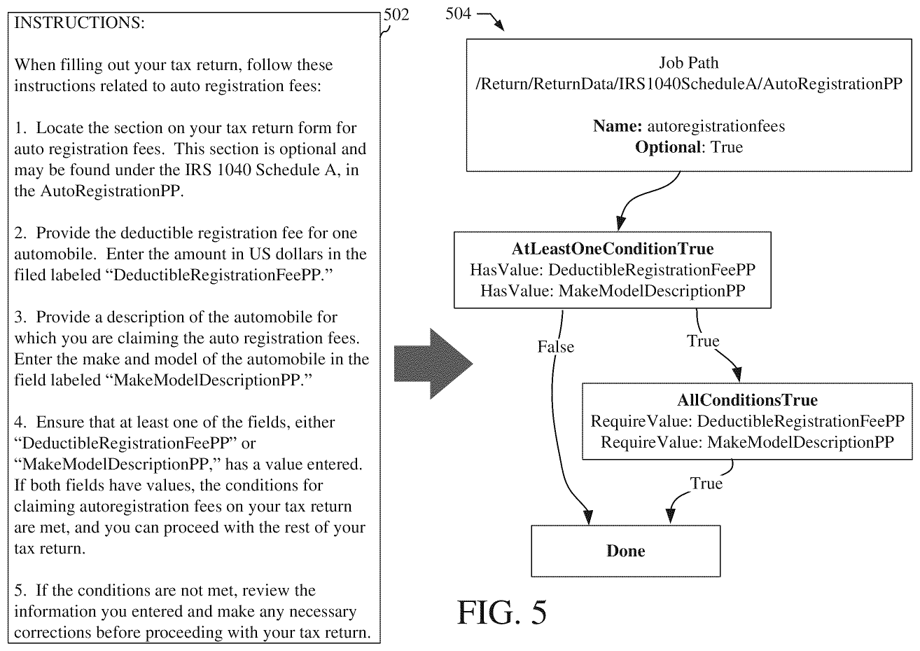

FIG. 5, by the way, illustrates an example of instructions 502 and an associated ground truth completeness graph 504, which may be included in the dataset of training data. The instructions, for example, include the domain knowledge, e.g., forms, rules, regulations, and any other relevant information, for which completeness graphs are to be prepared. The collected dataset of training data may additionally include relevant nodes from the schema extracted from the instructions. The relevant nodes may be extracted by the completeness graph generator after collection of the dataset or may be extracted, e.g., by a separate device, prior to collection of the dataset. Ground truth completeness graphs may be any previously generated completeness graphs for the associated instructions that are known to be correct. The ground truth completeness graphs, for example, may have been previously generated manually by domain experts. It may be desirable to improve the quality of the ground truth completeness graphs, e.g., by eliminating unnecessary verbose information and provide simplified identifiers. The dataset quality may be further improved by verifying the consistency and measure quality of data in the dataset, and including more sources of data for instructions and verifying that assumptions are feasible. In general, the ground truth completeness graph may be obtained from a current production system and accordingly are known to be accurate.

The policy may be a large language model (LLM) that performs the action of generating or editing a completeness graph in response to an input prompt and a data model from the instructions, such as tax forms and instructions on how to file the tax form. By way of example, the policy may be GPT-Neo 125M, which is a transformer model designed using EleutherAl's replication of the GPT-3 architecture, or other appropriate LLMs. The completeness graphs generated by the policy, for example, may be represented in JSON (JavaScript Object Notation) format. In some implementations, a pre-trained model (LLM) may be used as the policy. In some implementations, the pre-trained model (LLM) may be adapted and fine-tuned in order to enhance learning and understanding of completeness to generate completeness graphs in the desired format.

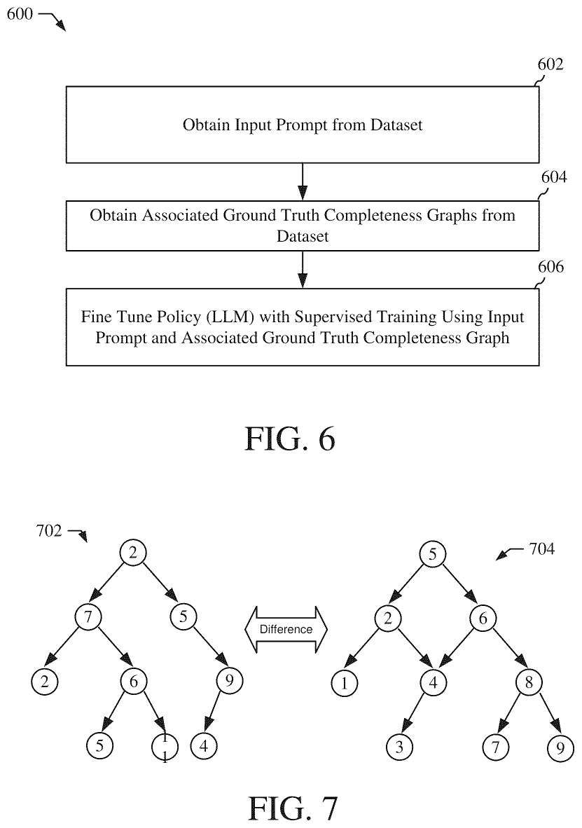

FIG. 6 shows an illustrative flowchart depicting an example method 600 for fine tuning the pre-trained model (LLM) using domain adaptation techniques in order to generate completeness graphs. As illustrated, sample input prompts may be obtained from the data set (602). The sample input prompts from the dataset of training data, for example, may be the instructions and/or nodes associated with the instructions. Ground truth completeness graphs associated with the input prompts are likewise obtained (604) and serve as labels for supervised training of the policy.

The policy (LLM) is fine-tuned with supervised training using the input prompts and the associated ground truth completeness graphs (606). For example, the ground truth completeness graphs may serve as labels for the supervised training and the policy may be fine-tuned using a domain adaptation technique, such as parameter-efficient fine-tuning (PEFT). The use of PEFT is advantageous to adapt the large scale pre-trained model to a new task, such as generating completeness graphs, without significantly increasing the number of parameters. In some implementations, the PEFT method for fine-tuning the policy may be Low-Rank Adaptation (LoRA) to enhance the learning and understanding of the policy for completeness graphs. LoRA, for example, freezes pre-trained model weights and injects trainable rank decomposition matrices, which significantly decreases computational and storage requirements, and overcomes issues of catastrophic forgetting, which is a behavior observed during full fine-tuning of LLMs.

Referring to FIG. 4, the method 400 further includes collecting comparison data and training a reward model for completeness graphs (block 404). For example, the comparison data may be collected by providing input prompts from the dataset of training data to the policy (LLM) and collecting the resulting generated completeness graphs produced by the completeness graph generator. The comparison data thus include generated completeness graphs and associated ground truth completeness graphs. The reward model may be constructed as an LLM or other appropriate model to compute the reward based on comparison to the ground truth completeness graphs. A dense reward model may be built by giving more weight to semantic similarity that would push the agent to learn the domain logic, e.g., tax logic. Dense rewards are provided to evaluate the agent in many different states while, in comparison, sparse rewards are given for only a limited number of states or events. The agent will require additional exploration with sparse rewards to obtain rewards and learn the optimal policy. The use of dense rewards, on the other hand, enables the agent to be quickly guided towards its learning goal. In some implementations, human verification of the validation set may be used to assist in constructing the reward model.

The reward model is trained with the comparison data to produce a first scalar value, e.g., 0-5, based on the closeness, e.g., semantic similarity, of the generated completeness graph and the associated ground truth completeness graph. The semantic similarity of the generated completeness graph and the associated ground truth completeness graph, for example, may be generated based on an edit distance of the generated completeness graph from the ground truth completeness graph.

FIG. 7, by way of example, illustrates a comparison of a generated completeness graph 702 produced by the pre-trained LLM in response to an input prompt and the associated ground truth completeness graph 704 to determine the semantic similarity. The semantic similarity between graph 702 and 704 may be determined based on the graph edit distance defined as the minimum cost of edit path (sequence of node and edge operations) to transform graph 702 to graph isomorphic to graph 704. The graph edit distance, for example, may be determined utilizing NetworkX based graph algorithms in Python for accuracy in calculating similarity of the graphs.

The reward model may be further trained to produce a second scalar value based on the validity of the completeness graph, e.g., based on the resulting format of the generated completeness graph, the node types, and edge restrictions of the completeness graph. For example, a completeness graph may be evaluated and the second scalar value decreased if it is represented in not in proper JSON format, if only a single node is present or one or more nodes do not properly represent relevant information or decision point, or if a node is unconnected to an edge, or if a node is connected to multiple edges, etc. A completeness graph may be considered valid if every node in the graph has a path from the start node and has a path to at least one of the end nodes. Moreover, there should not be any cycles in the completeness graph. The NetworkX based graph algorithm may be used for validity evaluation, such as cycle detection and path existence determination. The reward model may be configured to combine the first and second scalar values, e.g., average, sum, weighted sum, etc., to generate the reward.

The method 400 in FIG. 4 further includes optimizing the policy against the reward model (block 406). The use of a policy gradient reinforcement learning algorithm ensures stable training that updates the policy conservatively and controls agent behavior via constraints on gradient update steps. Optimization may employ Proximal Policy Optimization (PPO), which in some implementations may use Kullback-Leibler (KL)-divergence to generate an additional reward signal to prevent destabilization of the learning process.

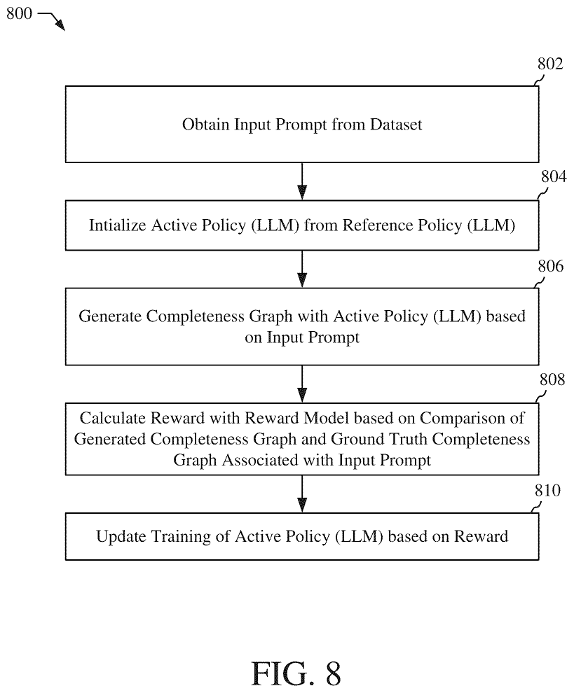

FIG. 8 is a flow chart depicting an example method 800 for optimizing the policy using a reward model. As illustrated, sample input prompts may be obtained from the data set (block 802). The sample input prompts from the dataset of training data, for example, may be the instructions and/or nodes associated with the instructions and the associated ground truth completeness graphs.

An active policy (active LLM) is initialized from a reference policy (LLM) (block 804). The active policy is the policy that will be trained during optimization, while the reference policy remains unchanged during optimization. The reference policy, for example, may be the policy capable of generating completeness graphs obtained at block 402 in FIG. 4, which may be fine-tuned using a domain adaptation technique, such PEFT, as discussed above. The active policy may be simply a copy of the reference policy.

The active policy generates a generated completeness graph based on the input prompt (block 806). The generated completeness graph, by way of example, may be produced in a zero-shot mode, i.e., the first completeness graph may be generated without providing the active policy with an example of how the completeness graph should look.

The generated completeness graph is provided to the reward model, which determines a reward based on a comparison of the generated completeness graph and the associated ground truth completeness graph (block 808). The reward model, for example, may be trained, as discussed above, to determine the reward based on closeness, e.g., semantic similarity, of the generated completeness graph and the associated ground truth completeness graph, which may be determined based on the graph edit distance. The reward model may additionally be determined based on the validity of the generated completeness graph, e.g., based on the validity of the format, the types of nodes, and edge restrictions for a completeness graph, as discussed above. Thus, the reward value may be a scalar value for closeness, validity, or a combination thereof (e.g., average, weighted average, etc.).

The active policy is updated based on the reward (block 810). The active policy, for example, may be trained with the PPO algorithm based on the reward.

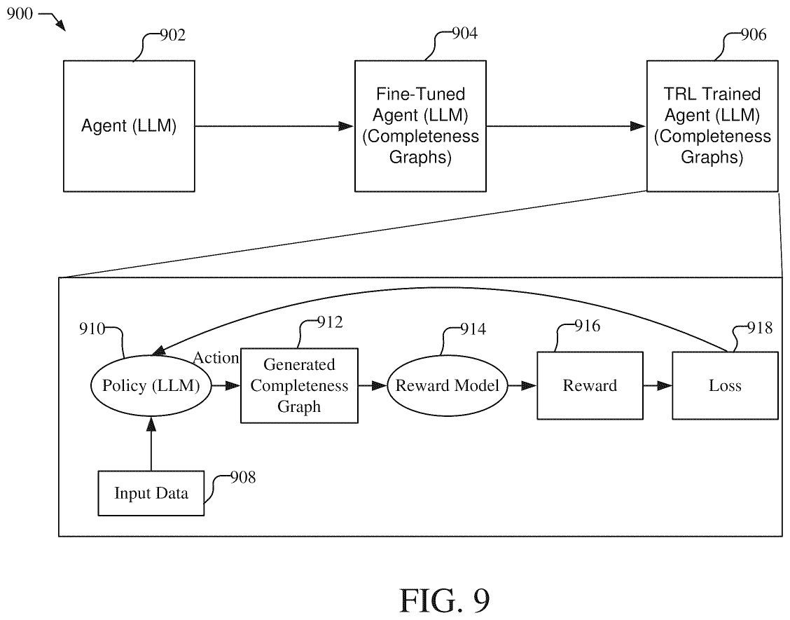

FIG. 9 illustrates the process 900 of generating the completeness graph generator using transformer based reinforcement learning, as discussed herein. As illustrated, an initial agent 902 for the completeness graph generator is obtained. As discussed above, the agent 902 employ a policy, e.g., an LLM such as GPT-Neo 125M. The agent 902 may be fine-tuned 904 using domain adaptation techniques, such as PEFT and LoRA, so that the agent can completeness graphs in response to a query, as discussed above. The agent may then be trained using transformer based reinforcement learning (TRL) to produce a TRL trained agent 906 that is configured to generate accurate generate completeness graphs.

Block 908 illustrates the training of the TRL trained agent 906. As illustrated, input data, such as instructions and/or nodes associated with the instructions and the associated ground truth completeness graph, from the dataset of training data, e.g., stored in database 120, is provided as a query to the policy (LLM) 910, which in response produces a generated completeness graph 912. The generated completeness graph and associated ground truth completeness graph are provided to the reward model 914. The reward model 914 compares the generated completeness graph and associated ground truth completeness graph, e.g., based on the graph edge distance, to determine the closeness of the graphs, e.g., semantic similarity. The reward model 914 may further evaluate the validity of the generated completeness graph, e.g., based on format, nodes, and edges. The reward model 914 provides a reward 916, which may be a scalar value, that is used in a loss function 918 to update the policy 910. The process of training the policy may employ multiple iterations until the loss function is minimized and the output of the policy 910 is close to the ground truth closeness graph. Training may further be performed using multiple different input data in block 908. In some implementations, it may be desirable to additionally employ Kullback-Leibler (KL)-divergence to generate an additional reward signal to prevent destabilization of the learning process.

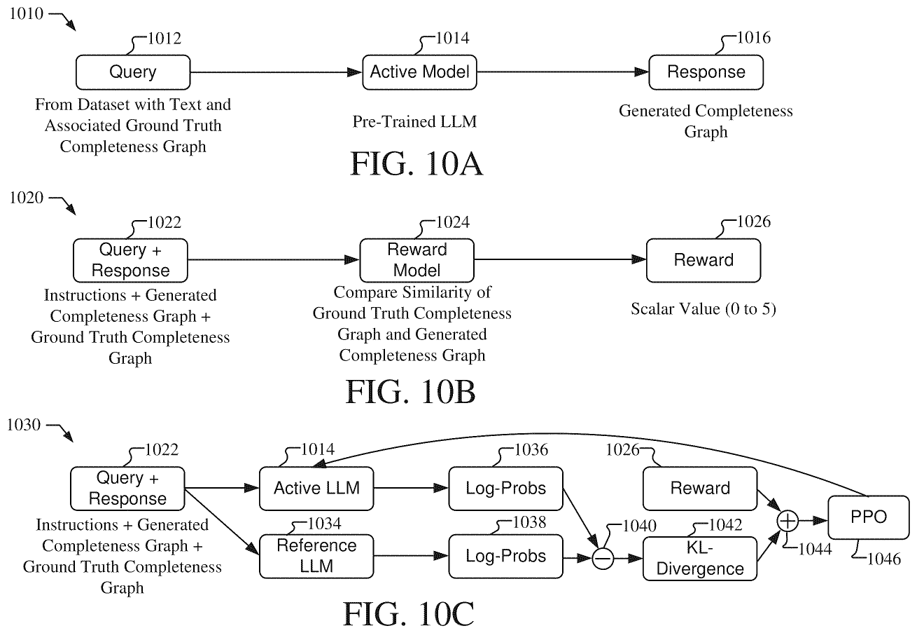

FIGS. 10A-10C, by way of example, illustrate a process of training the active model (LLM) with PPO based on the reward. FIG. 10A, for example, illustrates a rollout process 1010, in which a query 1012 (or input data) is obtained from the dataset of training data. The query may include, e.g., the instructions and/or nodes associated with the instructions and the associated ground truth completeness graph. The query is proved to the active model 1014, which may be the pre-trained LLM, which produces a generated completeness graph as a response 1016 to the query. At each step or iteration of updating the model (LLM) 1014 with the PPO process, the active model (LLM) 1014 will produce a new generated completeness graph as a response 1016 to the query.

FIG. 10B illustrates the evaluation process 1020, which is performed at each step or iteration of updating the model (LLM) 1014 with the PPO process. A query 1022 is obtained based on the query 1012, including the instructions and/or nodes associated with the instructions and the associated ground truth completeness graph, and the response 1016, i.e., the generated completeness graph. The query 1022 is provided to the reward model 1024, which compares the associated ground truth completeness graph and the generated completeness graph to determine closeness, e.g., semantic similarity based on graph edit distance. The reward model 1024 may also evaluate the validity of the generated completeness graph. The reward model 1024 generates a reward 1026, e.g., a scalar value (0 to 5) based on the closeness of the associated ground truth completeness graph and the generated completeness graph. The reward 1026 may be further based on the evaluation of the validity of the generated completeness graph.

FIG. 10C illustrates the optimization process 1030, which is performed at each step or iteration of updating the model (LLM) 1014 with the PPO process. In the optimization process 1030, the responses of the active model 1014 and the reference model 1034 (which is not updated) to the same query 1022 are compared, e.g., using the Kullback-Leibler (KL)-divergence to generate an additional reward signal to prevent destabilization of the learning process. Thus, as illustrated, the query 1022 (used in the evaluation process 1020) is provided to both the active model 1014 and the reference model 1034, from which the log-probabilities 1036 and 1038 of the tokens in the responses (i.e., generated completeness graphs) from each of the active model 1014 and reference model 1034, respectively, are determined. The log-probabilities 1036 and 1038 are combined 1040 and used to determine the KL-divergence 1042. The KL-divergence term, sometimes written as r=rp-rrKL (where rp is the response from the active model and rr is the reference model), is a penalty that prevents training from moving the active model substantially away from the reference model with each training batch. Without the KL-divergence term, the optimization process, for example, may begin to train the active model to generate text in the completeness graph that is gibberish, but that fools the reward model to generate a high reward. The KL-divergence 1042 and the reward 1026 from the reward model 1024 are combined 1044 and used for the PPO 1046 update of the active model 1014.

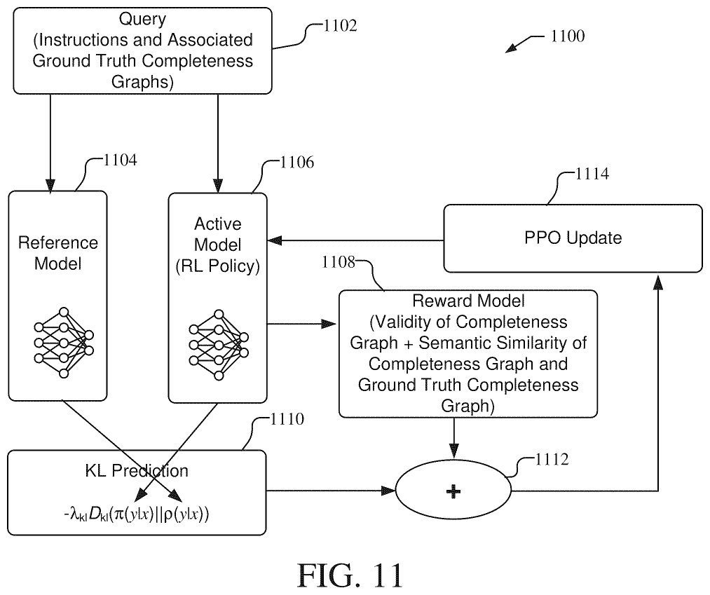

FIG. 11 illustrates a process 1100 of fine tuning the reinforcement learning using KL divergence. As illustrated, a query 1102 including instructions and/or nodes associated with the instructions and the associated ground truth completeness graph is provided to both a reference model 1104 and the active model 1106. The active model 1106 is the RL policy that will be trained during optimization and is initialized from the reference model, which will remain unchanged during optimization.

The generated completeness graph produced by the active model 1106 in response to the query (and the associated ground truth completeness graph) are provided to the reward model 1108, which generates a reward based on the closeness of the associated ground truth completeness graph and the generated completeness graph. The reward from the reward model 1108 may be further based on the validity of the generated completeness graph.

Additionally, the generated completeness graphs produced by the reference model 1104 and the active model 1106 in response to the query are provided and used to KL-prediction 1110 to produce the KL-divergence term IKLDKL (p(y|x)∥r(y|x)), where IKL represents the scaling factor (or weight), term, DKL represents the KL Divergence, p (y|x) represents the query and response of the active model 1106 and r (y|x)) represents the query and response of the reference model 1104.

The KL-divergence term from the KL-prediction 1110 and the reward from the reward model 1108 are combined 1112 and provided to PPO update 1114 for updating the active model 1106. The active model 1106 is trained using PPO based on the loss function

$$R ( x , y ) = r ( x , y ) - βlog \frac{π ( y \vert x )}{ρ ( y \vert x )} , \qquad Eq . 1$$

where R (x,y) is the total reward, and first term, r (x,y), is the output of the reward model 1108 and the second term,

$$β log \frac{π ( y \vert x )}{ρ ( y \vert x )} ,$$

is the KL divergence, which ensures that the active model does not deviate too far from the reference model while fine-tuning. The loss function is optimized using the PPO algorithm.

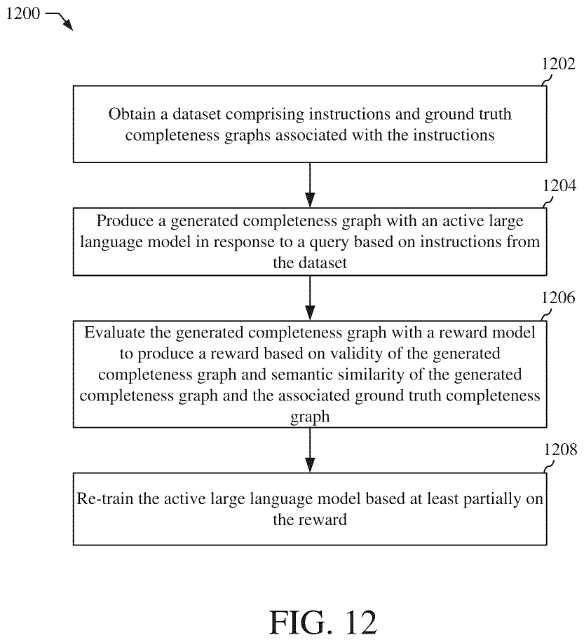

FIG. 12 shows an illustrative flowchart depicting an example method 1200 for training a large language model to generate completeness graphs, according to some implementations. The example method 300 is described as a computer-implemented method, e.g., performed by the computing system 100, such as by the one or more processors 130 executing instructions to perform operations associated with generation of the completeness graphs and described in reference to FIGS. 2-11.

At 1202, a dataset that includes instructions and ground truth completeness graphs associated with the instructions is obtained. The dataset, for example, may be obtained via the electronic interface 110 and the dataset may be stored in the database 120 shown in FIG. 1. Obtaining the dataset, for example, is discussed in relation to block 402 in FIG. 4 and in FIGS. 8, 9, 10A and 11. The instructions and ground truth completeness graphs associated with the instructions is training data. The instructions include domain knowledge including, e.g., forms, rules, regulations, and any other relevant information, from which completeness graphs are to be prepared. The instructions may be the raw text or may alternatively or additionally include relevant nodes from the schema extracted from the instructions. The ground truth completeness graphs may be previously generated completeness graphs for the associated instructions that are known to be correct. For example, the ground truth completeness graphs may have been previously generated manually by domain experts. The instructions may be for any desired domain, such as tax, finance, accounting, health care, data protection, etc.

At 1204, a generated completeness graph is produced with an active large language model in response to a query based on instructions from the dataset. Generation of the completeness graph by the active large language model, for example, is discussed in relation to block 406 in FIG. 4 and in FIGS. 8, 9, 10A, and 11. The generated completeness graph, by way of example, may be produced in a zero-shot mode.

At 1206, the generated completeness graph is evaluated with a reward model to produce a reward based on validity of the generated completeness graph and semantic similarity of the generated completeness graph and the associated ground truth completeness graph. By way of example, the evaluation of the generated completeness graph with the reward model is discussed in relation to block 404 in FIG. 4 and in FIGS. 7, 8, 9, 10B, and 11.

At 1208, the active large language model is re-trained based at least partially on the reward. Re-training, e.g., optimizing, the active large language model is discussed in relation to block 406 in FIG. 4 and in FIGS. 8, 9, 10C, and 11.

The method may further include training a reference large language model to receive instructions from the dataset and in response to produce completeness graphs, wherein the active large language model is initialized based on the reference large language model. By way of example, training a reference large language model is discussed in relation to block 402 in FIG. 4 and FIGS. 6 and 9. The training of the reference large language model, for example, may be fine-tuning a pre-trained large language model using domain adaptation techniques, such as PEFT and LoRA. The training of the reference large language model may include supervised training using instructions from the dataset as prompts and the ground truth completeness graphs associated with instructions as labels.

The method may further include producing a second generated completeness graph with the reference large language model in response to the query based on the instructions from the dataset. Producing a second generated completeness graph with the reference large language model, for example, is discussed in relation to block 406 in FIG. 4 and in FIGS. 10C and 11. Additionally, the generated completeness graph produced with the active large language model is compared to the second generated completeness graph produced with the reference large language model to determine a divergence, e.g., as discussed in relation to block 406 in FIG. 4 and in FIGS. 10C and 11. By way of example, comparing the generated completeness graph produced with the active large language model to the second generated completeness graph produced with the reference large language model may include determining a Kullback-Leibler (KL) divergence. The re-training of the active large language model is further based at least partially on the divergence, e.g., as discussed in relation to FIGS. 10C and 11.

The method may further include determining a loss based on the reward and the divergence, e.g., as discussed in relation to FIGS. 10C and 11. The re-training of the active large language model may be based on the loss. The re-training of the active large language model based on the loss, for example, may include performing a Proximal Policy Optimization (PPO) algorithm.

In some implementations, evaluating the generated completeness graph with the reward model to produce the reward may include determining the validity of the generated completeness graph based on the validity of one or more of a file type, node types, and edges of the generated completeness graph, e.g., as discussed relation to block 404 in FIG. 4 and in FIGS. 7, 8, 9, 10B, and 11. The semantic similarity of the generated completeness graph and the associated ground truth completeness graph may be determined based on a graph edit distance between the generated completeness graph and the associated ground truth completeness graph, e.g., as discussed in relation to block 404 in FIG. 4 and in FIGS. 7, 8, 9, 10B, and 11. The validity and the semantic similarity may be converted to a scalar value as the reward, e.g., as discussed in relation to block 404 in FIG. 4 and in FIGS. 7, 8, 9, 10B, and 11.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally in terms of functionality, and illustrated in the various illustrative components, blocks, modules, circuits and processes described above. Whether such functionality is implemented in hardware or software depends upon the particular application and design constraints imposed on the overall system.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method of training a large language model to generate completeness graphs, comprising:
obtaining a dataset comprising instructions and ground truth completeness graphs associated with the instructions;
producing a generated completeness graph with an active large language model in response to a query based on instructions from the dataset;
evaluating the generated completeness graph with a reward model to produce a reward based on validity of the generated completeness graph and semantic similarity of the generated completeness graph and the associated ground truth completeness graph; and
re-training the active large language model based at least partially on the reward.

2. The method of claim 1, further comprising training a reference large language model to receive instructions from the dataset and in response to produce completeness graphs, wherein the active large language model is initialized based on the reference large language model.

3. The method of claim 2, wherein training the reference large language model comprises supervised training using instructions from the dataset as prompts and the ground truth completeness graphs associated with instructions as labels.

4. The method of claim 2, further comprising:
producing a second generated completeness graph with the reference large language model in response to the query based on the instructions from the dataset; and
comparing the generated completeness graph produced with the active large language model to the second generated completeness graph produced with the reference large language model to determine a divergence;
wherein the re-training of the active large language model is further based at least partially on the divergence.

5. The method of claim 4, wherein comparing the generated completeness graph produced with the active large language model to the second generated completeness graph produced with the reference large language model comprises determining a Kullback-Leibler (KL) divergence.

6. The method of claim 4, further comprising determining a loss based on the reward and the divergence, wherein the re-training of the active large language model is based on the loss.

7. The method of claim 6, wherein the re-training of the active large language model based on the loss comprises performing a Proximal Policy Optimization (PPO) algorithm.

8. The method of claim 1, wherein the evaluating the generated completeness graph with the reward model to produce the reward comprises:
determining the validity of the generated completeness graph based on the validity of one or more of a file type, node types, and edges of the generated completeness graph;
determining the semantic similarity of the generated completeness graph and the associated ground truth completeness graph based on a graph edit distance between the generated completeness graph and the associated ground truth completeness graph; and
converting the validity and the semantic similarity to a scalar value as the reward.

9. A system of training a large language model to generate completeness graphs, comprising:
one or more processors; and
a memory coupled to the one or more processors and storing instructions that, when executed by the one or more processors, cause the one or more processors to perform operations comprising:
obtain a dataset comprising instructions and ground truth completeness graphs associated with the instructions;
produce a generated completeness graph with an active large language model in response to a query based on instructions from the dataset;
evaluate the generated completeness graph with a reward model to produce a reward based on validity of the generated completeness graph and semantic similarity of the generated completeness graph and the associated ground truth completeness graph; and
re-train the active large language model based at least partially on the reward.

10. The system of claim 9, wherein the one or more processors are further configured to perform operations comprising train a reference large language model to receive instructions from the dataset and in response to produce completeness graphs, wherein the active large language model is initialized based on the reference large language model.

11. The system of claim 10, wherein the one or more processors are configured to perform the operation of train the reference large language model by being configured to supervised train using instructions from the dataset as prompts and the ground truth completeness graphs associated with instructions as labels.

12. The system of claim 10, wherein the one or more processors are further configured to perform operations comprising:
produce a second generated completeness graph with the reference large language model in response to the query based on the instructions from the dataset; and
compare the generated completeness graph produced with the active large language model to the second generated completeness graph produced with the reference large language model to determine a divergence;
wherein the re-training of the active large language model is further based at least partially on the divergence.

13. The system of claim 12, wherein the one or more processors are configured to perform the operation of compare the generated completeness graph produced with the active large language model to the second generated completeness graph produced with the reference large language model by being configured to determine a Kullback-Leibler (KL) divergence.

14. The system of claim 12, wherein the one or more processors are further configured to perform operations comprising determine a loss based on the reward and the divergence, wherein the re-training of the active large language model is based on the loss.

15. The system of claim 14, wherein the one or more processors are configured to perform the operation of re-train of the active large language model based on the loss by being configured to perform a Proximal Policy Optimization (PPO) algorithm.

16. The system of claim 9, wherein the one or more processors are configured to perform the operation of evaluate the generated completeness graph with the reward model to produce the reward by being configured to perform:
determine the validity of the generated completeness graph based on the validity of one or more of a file type, node types, and edges of the generated completeness graph;
determine the semantic similarity of the generated completeness graph and the associated ground truth completeness graph based on a graph edit distance between the generated completeness graph and the associated ground truth completeness graph; and
convert the validity and the semantic similarity to a scalar value as the reward.
